(19) United States
(12) Patent Application Publication
(10) Pub. No.: US 2009/0193647 A1
(43) Pub. Date: Aug. 6, 2009

(54) Method for fabricating a feedback potentiometer

(76) Inventors: Tanh M. Bui, Hendersonville, TN (US); Christopher J. Billman, Springfield, TN (US)

Correspondence Address: JACOBSON HOLMAN PLLC, 400 SEVENTH STREET N.W., SUITE 600, WASHINGTON, DC, 20004, US

(21) Appl. No.: 12/068,067

(22) Filed: Feb. 1, 2008

(51) Int. Cl. H01C 17/00

(52) U.S. Cl. 29/610.1

(57) ABSTRACT

A method of fabricating a potentiometer in which conductive stampings are cut to be both the connector pins and the substrate of the potentiometer. In the region where the potentiometer is desired, an insulating layer covers the surface of the stamping. The insulating layer can be the same material as the solder mask, and electrically isolates the connector pins from the resistive area. Next, carbon trace is screen-printed over the insulating layer where the potentiometer is desired, and oven-cured. This subassembly is then placed into a housing of plastic or another insulating material. Last, the feedback and ground pins are assembled into the plastic housing. The ground pin is laid on top of the end of the carbon trace to make an electrical connection to the resistive trace.

### CROSS-REFERENCE TO RELATED APPLICATIONS

Not applicable.

### BACKGROUND OF THE INVENTION

1. Field of the Invention

The present invention relates to a method for fabricating feedback potentiometers on a printed circuit board. More specifically, the invention relates to a method for fabricating feedback potentiometers using polymer thick film (PTF) technology.

2. Related Art

The conventional method for fabricating feedback potentiometers employs depositing carbon ink onto a non-conductive substrate, with etched copper traces for interconnection, and soldered-on metal stampings as connector pins.

Starting out with a non-conductive substrate (a PCB laminate) 10 (FIG. 1A), copper traces 12A, 12B, 14, 16 are etched or deposited to create interconnecting traces (FIG. 1B). The traces 12A, 12B, and 14 are arranged generally parallel to each other. Traces 12A and 12B are generally the same width and length. Trace 14 is shorter than traces 12A and 12B. The upper part 15 of trace 14 mates with donut shaped trace 16. Carbon trace 18 is then screen-printed in the region where the potentiometer is desired (FIG. 1C), and oven-cured. After the carbon trace is oven-cured, a layer of solder mask (solder resist) 20 is deposited (FIG. 1D) and oven-cured to protect the conductive traces from being short-circuited. Finally, metal stampings 22A-22C are attached, typically by soldering to the substrate, for use as connector pins (FIG. 1E). Each stamping has a respective end connected to an end of one of the copper traces. Stamping 22A is connected to trace 12A, stamping 22B is connected to trace 14, and stamping 22C is connected to trace 12B The PCB assembly 30 is then assembled onto a housing of plastic or other insulating material.

Eichelberger et al. U.S. Pat. No. 4,345,236 shows an abrasion-resistant screen-printed potentiometer. Potentiometer 10 is preferably formed directly on a substrate 12 using a screen printing process. See col. 2, lines 31-42.

Dunn U.S. Pat. No. 6,507,993 shows a polymer thick-film (PTF) resistor printed on a planar circuit board surface. See. Col. 3, line 43 thru col. 5, lines 1-42.

Hall U.S. Pat. No. 7,140,271 shows a damper and an assembly therewith. See col. 2, line 64 thru col. 3, lines 1-53. See also Hall US 2006/0175422.

Lee et al. U.S. Pat. No. 6,194,990 shows a printed circuit board with a multilayer integral thin-film metal resistor and method therefore. See col. 3, lines 28-33.

Chacko U.S. Pat. No. 6,740,701 shows a resistive film for screen printing. See col. 10, lines 40-56.

The conventional method requires the use of soldered input terminals such as 22A-22C in FIG. 1E. The soldering process not only adds to manufacturing costs, it also raises several quality issues arising during manufacture. Among the issues are voids, cold solder joints, lifted solder pads, missed solder joints, and ECT (eddy current testing). In addition, the current soldering process uses lead solder, which is not environmentally sound.

The surface finish of the conventional method is inferior to the present invention because of the nature of the substrate material used in the conventional process. Typically, CEM1, CEM3, or FR4 laminates are used for the PCB's. This becomes a problem where tight electrical noise requirements have to be met.

The likelihood of contamination between the substrate and the resistive layers is greater with the prior art method. This is due to the material used to form the substrate. The substrate material used in the conventional process can delaminate if it is exposed to excessive moisture.

It is the solution of these and other problems that the present invention is directed.

### SUMMARY OF THE INVENTION

It is accordingly a primary object of the present invention is to provide a process for forming a feedback potentiometer on a printed circuit board using polymer thick film technology.

It is another object of the invention to provide a polymer thick film feedback potentiometer on a printed circuit board.

These and other objects are achieved by a method of fabricating a potentiometer in which conductive stampings are cut to be both the connector pins and the substrate of the potentiometer. In the region where the potentiometer is desired, an insulating layer covers the surface of the stamping. The insulating layer can be the same material as the solder mask such as liquid epoxy, which is typically applied to the conventional PCB where soldering takes place, to prevent an inadvertent short-circuit condition. The insulating layer electrically isolates the connector pins from the resistive area. Next, carbon trace is screen-printed over the insulating layer where the potentiometer is desired, and oven-cured. This subassembly is then placed into a housing of plastic or another insulating material such as polypropylene or Nylon In low volume production, the subassembly is placed into the housing by hand. In high volume production, the subassembly in placed into the housing using a pick and place robot. Last, the feedback and ground pins are assembled into the plastic housing. The ground pin is laid on top of the end of the carbon trace to make an electrical connection to the resistive trace.

Other objects, features and advantages of the present invention will be apparent to those skilled in the art upon a reading of this specification including the accompanying drawings.

### BRIEF DESCRIPTION OF THE DRAWINGS

The invention is better understood by reading the following Detailed Description of the Preferred Embodiments with reference to the accompanying drawing figures, in which like reference numerals refer to like elements throughout, and in which:

FIGS. 1A-1E illustrate the steps in the conventional method for fabricating a feedback potentiometer.

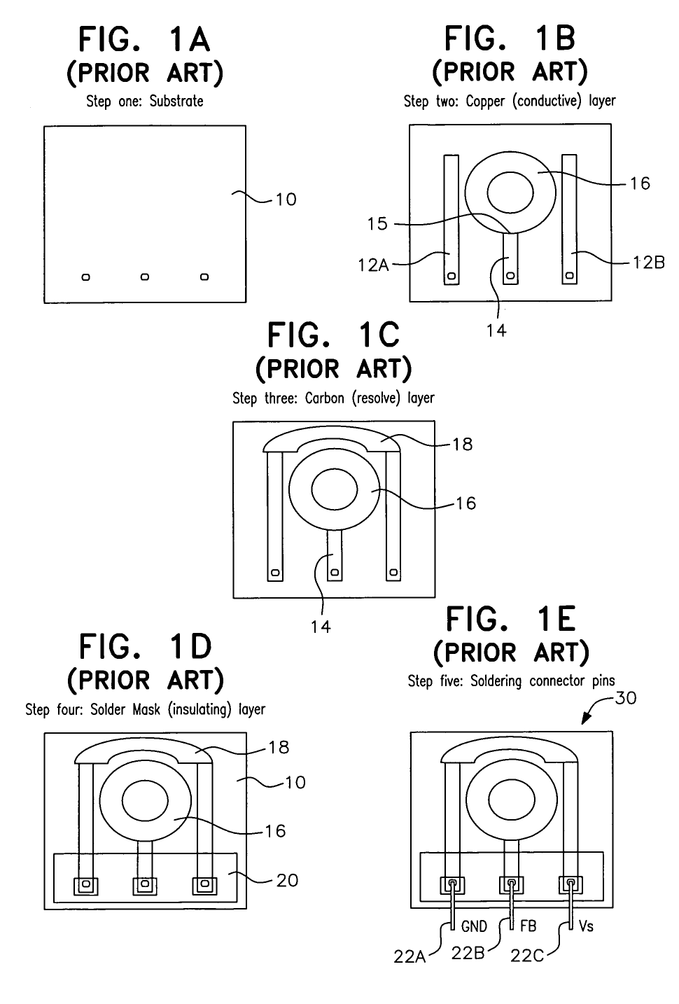

FIGS. 2A-2D illustrate the steps in a method for fabricating a feedback potentiometer in accordance with the present invention.

### DETAILED DESCRIPTION OF THE PREFERRED EMBODIMENTS

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

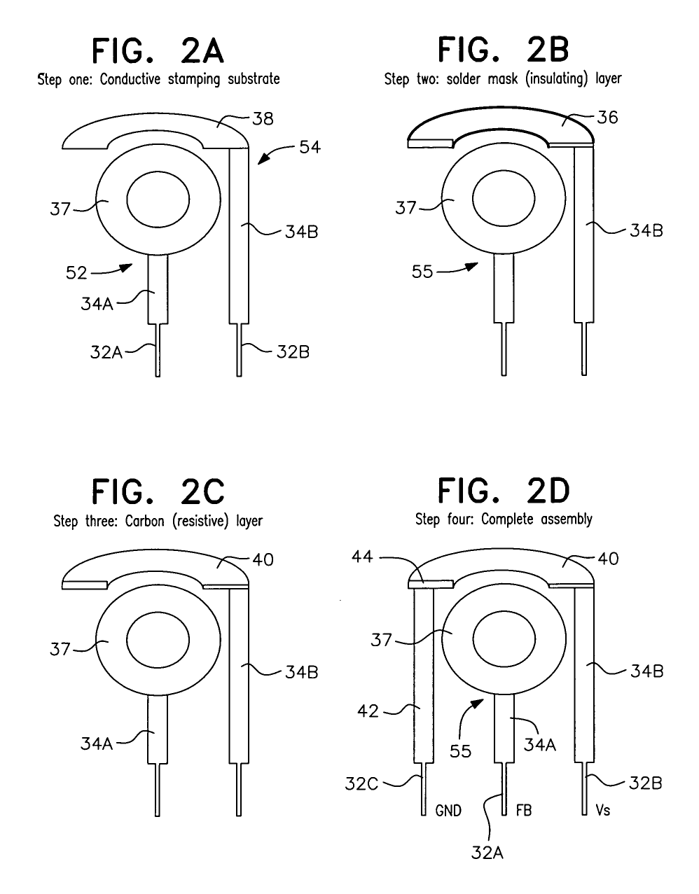

In the method in accordance with the present invention, in a first step (FIG. 2A), conductive stampings 52, 54 are cut to be both the connector pins (that is, the voltage pin 32B of stamping 54 and the feedback pin 32A of stamping 52) and the substrate 34A, 34B, 37 and 38 of the potentiometer. In a second step (FIG. 2B), the surface of the stamping 38 where the potentiometer is desired is covered with an insulating layer 36. This insulating layer can be the same material as the solder mask, which is typically applied to the conventional PCB where soldering takes place, to prevent an inadvertent short-circuit condition. In a third step (FIG. 2C), carbon trace 40 is screen-printed over the insulating layer 36, where the potentiometer is desired, and oven-cured. In a fourth, final step (FIG. 2D), the feedback pin 32A and ground pin 32C are assembled into the same plastic housing as mentioned before. The ground pin 32C must be laid on top of the end of the carbon trace 42 to make an electrical connection to the resistive trace, Vₛ.

As constructed the substrates 34A, 34B, and 42 are arranged generally parallel to each other. Substrates 32B and 42 are generally the same width and length. Substrate 34A is shorter than substrates 42 and 34B. The upper part 55 of substrate 34A mates with donut shaped substrate 37.

The conductive stampings 32A, 32B, 32C, 34A, 34B, 37, 38, and 42 are preferably made from a brass alloy. In a preferred embodiment, the brass alloy is a member of the phosphor bronze family. In a preferred embodiment, the thicknesses of the conductive stampings are about 0.64 mm. The solder mask insulating layer is preferably made from a liquid epoxy. Finally, the carbon resistive layer 40 is preferably formed using a cured carbon ink. The thickness of the carbon resistive layer 40 is about 10 microns.

Modifications and variations of the above-described embodiments of the present invention are possible, as appreciated by those skilled in the art in light of the above teachings. The present invention has only three components whereas the prior art method has six. Further the improved method eliminates the broken trace failure mode that can occur in the conventional process during the singulation process. It is therefore to be understood that, within the scope of the appended claims and their equivalents, the invention may be practiced otherwise than as specifically described.

What is claimed is:

1. A method for fabricating a feedback potentiometer, comprising the steps of:
creating a predetermined number of conductive stampings configured to be both connector pins and a substrate of the potentiometer;
covering the surface of the stamping where the potentiometer is desired with an insulating material to form an insulating layer;
covering the insulated layer with carbon trace; and
assembling at lease two connector pins into the same housing.

2. The method of claim 1, wherein the conductive stampings define a ground pin, a feedback pin, and a voltage pin.

3. The method of claim 2, wherein the connector pins in the housing are the feedback pin and the ground pin.

4. The method of claim 1, wherein a predetermined number of the conductive stampings form substrates that are generally parallel to each other.

5. The method of claim 1, wherein a predetermined number of the conductive stampings form substrates that are generally the same width and length.
